(19) United States
(12) Patent Application Publication
(10) Pub. No.: US 2012/0253810 A1
(43) Pub. Date: Oct. 4, 2012

(54) COMPUTER PROGRAM, METHOD, AND SYSTEM FOR VOICE AUTHENTICATION OF A USER TO ACCESS A SECURE RESOURCE

(76) Inventors: Timothy S. Sutton, Overland Park, KS (US); Stephen T. Dispensa, Leawood, KS (US)

(21) Appl. No.: 13/434,303

(22) Filed: Mar. 29, 2012

Related U.S. Application Data
(60) Provisional application No. 61/469,087, filed on Mar. 29, 2011.

(51) Int. Cl. G10L 17/00

(52) U.S. Cl. 704/246; 704/E15.001

(57) ABSTRACT

Authenticating a purported user attempting to access a secure resource includes enrolling a user's voice sample by requiring the user to orally speak preselected enrollment utterances, generating prompts and respective predetermined correct responses where each question has only one correct response, presenting a prompt to the user in real time, and analyzing the user's real time live response to determine if the live response matches the predetermined correct response and if voice characteristics of the user's live voice sample match characteristics of the enrolled voice sample.

### RELATED APPLICATION

This patent application claims priority benefit, with regard to all common subject matter, of earlier-filed U.S. Provisional Patent Application No. 61/469,087, filed Mar. 29, 2011, and entitled “VOICE BINDING.” The identified earlier-filed provisional patent application is hereby incorporated by reference in its entirety into the present application.

### BACKGROUND

1. Field

Embodiments of the present invention relate to computer programs, methods, and systems for authenticating a user to access a secure resource. More particularly, embodiments authenticate a purported user by confirming a live voice sample provided by the purported user is from a known user and is not a prerecorded sample or assembled/spliced user voice samples. Authentication is achieved by (1) performing a voice recognition of the purported user's live voice sample; and (2) simultaneously confirming the live voice sample is from a live person by analyzing the accuracy of a response provided in the live voice sample and in real time by the purported user in response to a prompt. A computer cannot sufficiently quickly synthesize, assemble, or splice user voice samples to obtain a real time correct response to an unknown prompt.

2. Related Art

Access to secure data resources at a secure data resource, such as a bank or a medical records facility, usually requires authentication of a user. A common method of authentication is for a purported user to supply their username and password, and if the supplied username and password match a previously enrolled username and password, then the user is authenticated. This method of authentication is well-known as being weak and subject to attacks. To buttress the strength of the username/password authentication method, many secure resources request the user answer a challenge question eliciting an answer that is personal to the user, such as the user's mother's maiden name, the user's favorite color, the user's high school, etc. Although perhaps slightly stronger than mere username/password alone, challenge questions requesting personal information are also weak. As a practical matter, it is relatively easy for an attacker to monitor entry of the answer to a challenge question. Additionally and unfortunately, many attacks on a user's account come from family members or friends who may be privy to the personal information requested by the challenge question.

To address the above weaknesses in accessing secure resources, biometric authentication, including recognition of a user's voice, is known. In biometric authentication, a user provides biometric indicia, such as the user's fingerprint or a voice sample, to match against an enrolled fingerprint or voice sample. Although more difficult to attack than a mere username/password combination, compromising or attacking enrolled biometric samples is still possible by using prerecorded voice samples or photographic images of fingerprints.

Yet another method of insuring authentic access to a secure resource is to employ multi-factor authentication. A user performs a first factor of authentication with something they know, such as a username and password. A second factor of authentication is also employed, such as requiring a security token to complete the authentication. Even these more stringent authentication methods are vulnerable to attack.

### SUMMARY

Embodiments of the present invention solve the above-mentioned problems and provide a computer program, a method, and a system for authenticating a user to access a secure resource. More particularly, embodiments verify an identity of a purported user by confirming a live voice sample, provided by the purported user in response to a prompt, is the known user, is not prerecorded, and is not assembled or spliced from user voice samples. The live voice sample is provided by the purported user in real time in response to the prompt. The prompt seeks to elicit from the purported user a verifiably correct response, such that the prompt has a unique response, i.e., only one correct response. The purported user's live voice sample having the response to the prompt is then analyzed by generally simultaneously performing a voice recognition of the live voice sample and analyzing the accuracy of the response. In embodiments of the present invention, the response to the prompt cannot be predicted in advance of the prompt being presented to the purported user, which thwarts the attacker's attempt to provide a forged voice sample with the correct response, to splice utterances of a recorded voice sample together to mimic the correct response, or to use a response generated by a non-human, e.g., a robot. Verifying the accuracy of the response provided in real time allows for confirming that the provided live voice sample was actually provided by a live person in real time.

In embodiments of the present invention, the known user first enrolls their voice sample by speaking a plurality of enrollment utterances, which may be preselected. Although embodiments of the present invention contemplate using a variety of voice recognition techniques, a common technique matches a live voice sample provided by the user against a recorded voice sample. Enrollment of the voice sample by the known user allows for a future comparison of the enrolled voice sample against a live voice sample provided by a purported user attempting to access the secure resource so as to perform the voice recognition of the user.

To prevent an attacker from imitating the known user via a prerecorded voice sample or by assembling or splicing prerecorded samples together, the live voice sample elicited from the user contains or otherwise is a response to a prompt. The prompt requires the user to provide a unique response, such that there is only one correct answer for the prompt. As such, the correct response to the prompt cannot be predicted in advance so as to allow an attacker to prerecord or synthesize the unique response or assemble/splice the response from obtained user voice samples. Embodiments of the present invention analyze the accuracy of the response to determine if it is the correct response, and such analysis is performed substantially simultaneously with the voice recognition. Thus, voice authentication is achieved by performing voice recognition of the live voice sample and simultaneously confirming that the live voice sample is not prerecorded or synthesized, assembled/spliced, or computer-generated by prompting the purported user to provide a real-time response that could not otherwise be known in advance of the user being presented with the prompt.

Embodiments of the present invention generate a set of prompts and respective predetermined correct responses for use in authenticating the user in future authentication sessions. Each respective predetermined correct response is unique; that is, each prompt has only one correct response. To perform the authentication, the prompt is presented to the user in real time via a user interface, such as a telephone or wireless communications device. The user then orally responds to the prompt in real time. The user's live oral response is then analyzed to determine if it matches the predetermined correct response, and further to determine if biological voice characteristics of the user's live voice sample match biological characteristics of the enrolled voice sample.

In some embodiments of the present invention, the correct response to the prompt does not pertain to information personal to the user and/or includes one or more words that are not one of the plurality of preselected enrollment utterances. In yet further embodiments of the present invention, the prompt (1) requests the user solve a mathematical equation; (2) requests the user repeat one or more words provided on a computing device associated with the user and in response to the user requesting access to the secure resource; (3) requests the user repeat one or more words, and such words were not one of the plurality of preselected enrollment utterances; and/or (4) is not an instruction to repeat one or more words, regardless of whether the word was one of the preselected enrollment utterances. Further, the prompts are chosen such that the response to a prompt cannot be generated by a computer in real time by assembling or splicing user voice samples.

Embodiments of the present invention can be used alone or in combination with a multi-factor authentication system, wherein the above-described authentication using the user's live voice sample is a secondary authentication, and the user first participates in a primary authentication, such as providing a username and password to the secure resource.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic depiction of a system for authentication of a user to a secure resource, constructed in accordance with various embodiments of the present invention; and

FIG. 2 is a flow chart of a method of authenticating the user to the secure resource.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

The present invention provides various embodiments of a computer program, a method, and an authentication system 10 for authenticating a user to access a secure resource. Exemplary, non-limiting secure resources include a website, an application for a wireless communications device, or other electronic source hosted on a third-party server and that cannot be accessed without proper authentication. For example, online banking websites or applications are often “locked” or otherwise secure. The user trying to access their online banking account must then provide at least one form of authentication information, such as a username and password. Another example of a secure resource is an electronic lock, such as a lock for a building or room, wherein if the user desires to access the building or room, the user must provide their authentication information to instruct the electronic lock to unlock.

The authentication system 10 of embodiments of the present invention comprises a voice recognition module that confirms that biological voice characteristics of a live voice sample match biological characteristics of an enrolled voice sample, and a human recognition module that confirms that a live oral response to a prompt is provided by a live human. In some embodiments of the present invention, the predetermined correct response to the prompt (a) is widely known or determinable by the general public; (b) does not involve or pertain to information personal to the user; (c) is unique (i.e., there is only one correct response); (d) is not capable of being generated by a computer using assembled/spliced user voice samples in real time; and (e) permits the authentication system 10 to compare the biological voice characteristics of the live voice sample provided via the oral response to biological characteristics of the enrolled voice sample of the user. In even further embodiments of the present invention, the user need not have uttered, as the enrolled voice sample, particular words (i.e., utterances) corresponding to the predetermined correct response to the prompt. In yet further embodiments of the present invention, the correct response to the prompt contains less than ten, five, four, three, two, two, or one words uttered for the enrolled voice sample. Alternatively, the correct response to the prompt does not contain any word uttered for the enrolled voice sample. Thus, the authentication system matches the enrolled voice sample to a real-time unique utterance provided in response to the prompt regardless of whether any of the enrollment utterances are the same as the real-time unique response utterances.

### Hardware Description

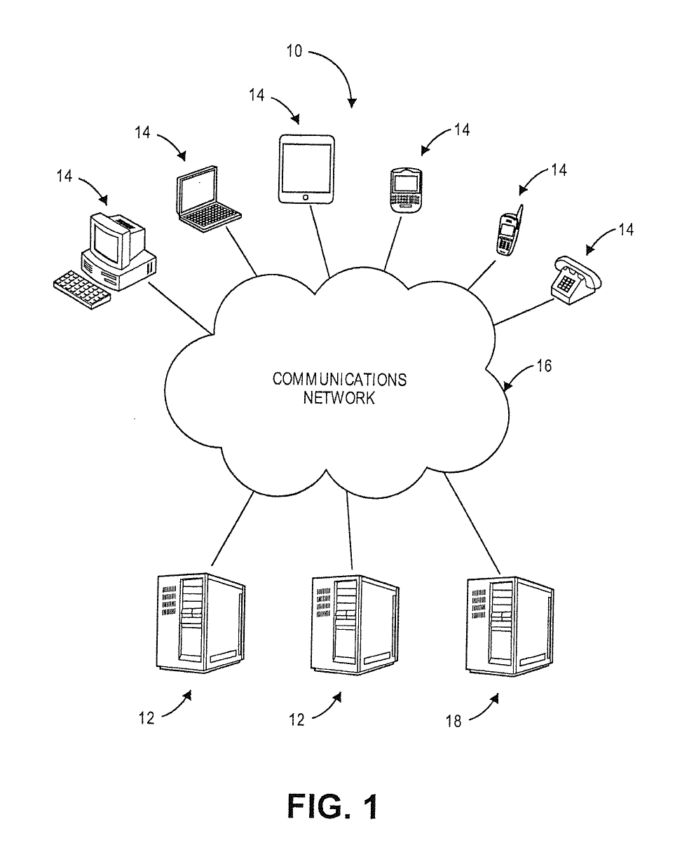

The computer program and the method may be implemented in hardware, software, firmware, or combinations thereof using the authentication system 10, shown in FIG. 1, which broadly comprises server devices 12, client devices 14, and a communications network 16. The server devices 12 may include computing devices that provide access to one or more general computing resources, such as Internet services, electronic mail services, data transfer services, and the like. The server devices 12 may also provide access to secured or restricted resources, such as financial accounts, medical records, personal information databases, intellectual property storage, and the like.

The computing device may include any device, component, or equipment with a processing element and associated memory elements. The processing element may implement operating systems, and may be capable of executing the computer program, which is also generally known as instructions, commands, software code, executables, applications, apps, and the like. The processing element may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, the server devices 12 may further include file stores comprising a plurality of hard disk drives, network attached storage, or a separate storage network.

The client devices 14 may include computing devices as described above. Examples of the client device 14 may include work stations, desktop computers, laptop computers, palmtop computers, tablet computers, portable digital assistants (PDA), smart phones, and the like, or combinations thereof. Various embodiments of the client device 14 may also include voice communication devices, such as cell phones or landline phones.

The communications network 16 may be wired or wireless and may include servers, routers, switches, wireless receivers and transmitters, and the like, as well as electrically conductive cables or optical cables. The communications network 16 may also include local, metro, or wide area networks, as well as the Internet, or other cloud networks. Furthermore, the communications network 16 may include cellular or mobile phone networks, as well as landline phone networks or public switched telephone networks.

Both the server devices 12 and the client devices 14 may be connected to the communications network 16. Server devices 12 may be able to communicate with other server devices 12 or client devices 14 through the communications network 16. Likewise, client devices 14 may be able to communicate with other client devices 14 or server devices 12 through the communications network 16. The connection to the communications network 16 may be wired or wireless. Thus, the server devices 12 and the client devices 14 may include the appropriate components to establish a wired or a wireless connection.

The computer program may run on one or more server devices 12. Thus, a first portion of the program, code, or instructions may execute on a first server device 12, while a second portion of the program, code, or instructions may execute on a second server device 12. In some embodiments, other portions of the program, code, or instructions may execute on other server devices 12 as well. For example, a first portion of the program, code, or instructions may execute on a financial institution server device 12, and a second portion of the program, code, or instructions may execute on a server device 12 that handles the voice recognition and presentation of a prompt or a secondary authentication request, as discussed in more detail below.

### Voice Recognition Module

The voice recognition module of embodiments of the present invention determines if the live voice sample provided by the user matches a previously enrolled voice sample. As an initial step, the voice recognition module enrolls a known user's voice sample. As is known in the art, voice recognition compares biological characteristics of a known user's voice to biological characteristics of a purported user's voice. Common voice recognition algorithms create a sound spectrogram of the known user's speech sounds and the purported user's speech sounds and perform a comparison and analysis of the two speech sounds or other acoustical qualities. Although common voice recognition algorithms employ spectrograms and comparison of the acoustic or other biological qualities of the enrolled and live voice samples, it should be appreciated that the present invention is not limited to such voice recognition techniques. As such, any voice recognition algorithm that compares and matches the voice samples of a known and purported user is encompassed within and may be employed by the present invention.

To enroll the user's voice sample, the system receives from a known user a plurality of preselected enrollment utterances, which comprise one or more words spoken by the known user. Use of the term “words” herein encompasses both words and numbers. The voice sample is provided via a user interface, such as over a communications device (e.g., telephone communicating over a public switched telephone network or mobile wireless communications device), a direct recording made via a microphone, a transmitted digital sound file, etc. A digital copy of the voice sample comprising the preselected enrollment utterances or characteristics of the voice sample is stored in one or more voice recognition databases accessible by the computing device, such as a second server device, of embodiments of the present invention and as discussed in detail below. Known, third-party voice recognition algorithms select the utterances to be spoken for enrollment of the user's voice, and it can be appreciated that various voice recognition algorithms may request the user to speak different utterances.

The preselected enrollment utterances are sufficient to match a live voice sample comprising any utterance, i.e., word or phrase. Thus, as discussed in detail below, the enrollment utterances are of the quality and nature to allow the voice recognition algorithm to match the known and purposed users' voice samples based on any live voice sample speaking or comprising any utterance and regardless of whether the live utterance is the same as any of the preselected enrollment utterances.

To complete enrollment of the voice sample for the known user, the user may provide certain identifying information, such as name, date of birth, social security number, account number for the secure resource to be accessed, etc., to the system, and such identifying information may be saved or otherwise associated with the digital copy of the enrolled voice sample comprising the preselected enrollment utterances. Additionally, biological voice characteristics for the known user, such as average pitch, cadence information, and the like, may be saved or associated with the known user's information stored in the voice recognition database.

After the known user's voice sample is enrolled, voice recognition for future authentication sessions can then take place. During a future authentication session, the voice recognition stage of the two-stage authentication system receives from a purported authenticated user (“purported user”) a live voice sample comprising at least one live utterance and then compares the live voice sample to the enrolled voice sample to determine if there is a match of the two voice samples. As with the enrolled voice sample, the live voice sample is provided via a user interface. The live voice samples may be stored in the voice print database for future reference and to improve the voice recognition for the particular user.

In more detail, the purported user speaks the live utterance in response to the prompt, as discussed in more detail below. In embodiments of the present invention, the live utterance comprises one or more words. A digital representation of the live utterance is then algorithmically compared, via the known, employed voice recognition algorithm, with the preselected enrollment utterances comprising the enrolled voice sample. The voice recognition algorithm compares the biological characteristics of the two samples and determines if there is a match, i.e., if there is a predetermined minimum percentage accuracy between the two samples. It should be appreciated that “matching” of the two samples is performed by the known voice recognition algorithm, and thus, various matching algorithms and degrees of acceptable accuracy may be employed.

### Human Recognition Module

If there is a match between the two samples, then at least one requirement is met for authentication of the user. However, to complete authentication of the user, the purported user's live oral response to the prompt must be compared to a predetermined correct response to the prompt via the human recognition module. In more detail, embodiments of the present invention evaluate the at least one live utterance received by the purported user to determine what word(s) were actually spoken by the purported user. The human recognition module employs known, third-party speech recognition algorithms, commonly speech-to-text algorithms, to determine the word(s) spoken by the purported user.

Once the word(s) corresponding to the purported user's live utterances is known, the live utterances are compared to the predetermined correct response to determine if the purported user accurately responded to the prompt. As noted above, the purpose of the human recognition module is to verify that the provided live voice sample came from a live person and was not generated by a computer or was a prerecorded voice sample. If it is determined that the purported user accurately responded to the prompt, then the user is authenticated to access the secure resource. Unlike prior art prompts that seek to verify the authenticity of the purported user by eliciting information personal to the user that presumably the general public does not know, embodiments of the present invention employ the prompt to prevent attackers from quickly and in approximate real time providing a non-live, unauthenticated copy of the user's voice or from providing a computer-generated response comprising assembled or spliced user voice samples obtained by an attacker. Therefore, the human recognition module elicits a response that cannot easily be generated by a computer or be prerecorded by an attacker.

The receipt of the response from the purported user is a real-time response to the user receiving the prompt. “Real time” as used herein is defined to be substantially commensurate with the particular proposed action. Thus, for example, the live oral response from the user of their response to the prompt is within seconds (e.g., ten or less seconds) from the user hearing the prompt via the user interface.

Some embodiments of the present invention may further include a semantic evaluation module that reviews the semantic usage of the purported user's live voice sample to detect any inconsistencies. The semantic evaluation module may compare word locations within the live oral response and use that information to improve context-sensitive phonemic recognition. The reviews and comparisons performed by the semantic evaluation module may employ an exact match, a fuzzy match, or a variety of subset matches.

Embodiments of the present invention provide the advantage of asking the user a prompt having a response that is unique. A “unique” response as used herein is defined as being the only correct response. Thus, a prompt having a unique response has only one correct response. As can be appreciated, the set of prompts having unique responses is almost limitless, but non-limiting examples include “what does one plus one equal”; “who is the first president of the United States”; “what color is the sky,” “of the following three words, say which word comes first in alphabetical order”; “of the following set of numbers, place the numbers in numerical order,” etc.

In further embodiments of the present invention, the response to the prompt is widely known or determinable by the general public. As such, the prompt preferably is not of a difficulty or obscurity level that the general public would not know it. For example, of the five hypothetical questions provided above, most likely all are of sufficient generality that the correct response is widely known or determinable by the general public in the United States. However, if the question “who is the first president of the United States” was asked in a foreign country, the response may not be widely known by the general public. Therefore, it should be appreciated that a prompt having a widely known or determinable response may be different depending on various parameters, such as geographical region, socioeconomic levels, age, etc.

In even further embodiments of the present invention, the response to the prompt does not involve or pertain to information personal to the user. Examples of information personal to the user include the user's date of birth, social security number, mother's maiden name, favorite color, etc. Thus, a response involving or pertaining to “information personal to the user” is not widely known by the general public.

It should be appreciated that the unique response elicited from the user prevents an attacker or malfeasant from easily prerecording a voice sample to play back as the “live” sample. Additionally, the elicited unique response cannot be easily spliced to play back as the “live” sample. To address the possibility that the attacker could obtain a copy of the enrolled voice sample and use one or more of the preselected enrollment utterances (i.e., the words required to be spoken by the known user to voice print the user) to play back as the “live” sample, the prompt does not elicit a response containing preselected enrollment utterances in embodiments of the present invention. Alternatively, the prompt elicits a response containing no more than ten, five, three, two, or one of the preselected enrollment utterances. Alternatively stated, the prompt elicits a response that includes one or more words that are not one of the preselected enrollment utterances. Yet even further embodiments of the present invention may allow certain common words, used in the relevant language and spoken as one of the preselected enrollment utterances, be spoken in an acceptable correct response. Common words may be, for example, “the,” “to,” “and,” etc. However, for a more uncommon word, such as “blue,” if such uncommon word is used as one of the preselected enrollment utterances, then such uncommon word would be subject to the above-described limitations of using the uncommon word in the correct response.

Similarly, the unique response elicited from the user prevents an attacker or malfeasant from using a computer to generate the response in real time. As noted above, one of the prompts could be “of the following set of numbers, place the numbers in numerical order,” etc. Of course, most general-purpose computers could perform this calculation and provide a response relatively quickly, if not almost instantly. However, as of the filing of the present application, computers generally cannot in real time respond to such a prompt presented in the course of an authentication request and using voice samples of the user. An attacker cannot simply provide a computer-generated voice sample because the live voice sample must be a matched voice sample to meet the voice recognition criteria. The other issue is that if an attacker has access to the known user's voice samples, regardless of whether it was the enrolled voice sample or not, the attacker could conceivably use the voice samples to provide the correct response to the prompt. In the common case, the attacker places a virus or malware on a user's computer, such as the user's personal computer, laptop, smartphone, tablet, etc., to record user voice samples. The processors provided in such exemplary computers are not sufficiently capable of assembling or splicing together in real time the recorded user voice samples to obtain the unique response to the prompt. Thus, embodiments of the present invention substantially prevent or otherwise make infeasible an attacker from using a computer-generated response comprising the user's assembled or spliced voice samples.

Yet another type of prompt requests the user repeat one or more words, and such words were not one of the preselected enrollment utterances required to be spoken by the user to voice print the user. For example, if the user is requested to repeat “dog, one, please,” then none of these words would have been used as the preselected enrollment utterances for enrolling the user's voice sample. Alternatively, the prompt requests the user repeat a plurality of words for the live voice sample, and no more than ten, five, three, two, or one of the words was used as one of the preselected enrollment utterances.

In some circumstances, the prompt is not an instruction to repeat one or more words. As such, the user's live oral response does not repeat back particular instructed words.

Another example of a prompt that elicits a unique response is a prompt that asks for a solution to a relatively simple mathematical equation. The above-discussed example of “what does one plus one equal” is an example of a prompt that requests the user solve a mathematical equation. Of course, any number of mathematical equations that are relatively simple and easily and quickly answerable by the general public could be used.

A particular prompt presented to a user is selected from a set of prompts, and embodiments of the present invention may comprise a plurality of sets of prompts. As such, particular sets of prompts may be preferred for use with particular segments of users. As an example, one set of prompts may be for particular use in the United States, whereas another set may be for use in another country. Alternatively, one set of prompts may be for use only with users who are employees of a particular company. In such a case, the set of prompts may include questions with responses that are likely known by the employees of the particular company. Thus, in even further embodiments of the present invention, the response to the prompt is widely known or determinable to only a predefined set of users. Preferably, the purported user is asked a question in the known user's preferred language. Additionally, each user may be assigned a set of prompts particular for the user, and the set of prompts for the particular user may have at least five, ten, twenty, fifty, one hundred, or five hundred questions contained therein.

A request generation database stores the prompts and predetermined correct responses, including identification of particular sets of prompts, and each user's request history, including prior prompts presented to the user and the intermediate time or number of questions since a particular prompt was presented to the user. Embodiments of the present invention may randomly select a question from the set of prompts or may select a question based on the frequency with which the question has been presented to the user. Thus, for example, selection of a prompt to present to the user from a particular set of prompts does not select a prompt presented to the user within at least the previous one, three, five, ten, twenty, or fifty authentications. Selection of the prompt with the above-described frequency or random limitations prevents an attacker from iteratively guessing what the next question will be and preparing a “live” voice sample accordingly.

Embodiments of the present invention provide for voice authentication with a multi-factor authentication system. In a multi-factor authentication system, at least two authentications of the purported user are performed, namely a primary authentication and a secondary authentication. Additional authentication, such as a tertiary authentication, may also be performed. In a non-limiting example of employing the above-discussed voice authentication to elicit a unique response to a prompt, embodiments provide a three-factor authentication comprising a primary, a secondary, and a tertiary authentication. In the primary authentication, the user requests access to the secure resource at which the user enters the primary authentication information, such as a username and password. If the primary authentication is successful, i.e., the user correctly entered the associated username and password, embodiments of the present invention instruct the authentication system 10 of the successful primary authentication. The system then performs the secondary and tertiary authentications, which may occur singly or substantially in combination with each other. In various embodiments, the primary and secondary authentications may be processed as disclosed in U.S. patent application Ser. No. 12/394,016, “ENHANCED MULTI FACTOR AUTHENTICATION,” filed Feb. 26, 2009, which is hereby incorporated by reference in its entirety.

If the user entered the primary authentication information along one communications channel, such as the Internet via the user's personal computer, then the secondary authentication is initiated along a second and different communications channel. Examples of different channels of communication may include a first communications channel being established from a first client device 14 transmitting data to the server device 12. A second communications channel may be established from the server device 12 transmitting voice to a second client device 14, such as a smart, cell, or landline phone. This example of two-channel communication may also be set up using the same client device 14. Thus, a user may use a smartphone as the client device 14 to establish a first communications channel using a web browser transmitting data to the server device 12. A second communications channel may be established with the server device 12 transmitting voice to the same smartphone. As a second example, first and second channels of communication may be established between the client device 14 and the server device 12 using first and second types of encryption. As a third example, the user may establish a first communications channel by executing a first application, such as a web browser, on a first client device 14 to contact the server device 12. The user may establish a second communications channel by executing a second application, on the first client device 14 or a second client device 14, that receives authentication messages from the server device 12.

A secondary authentication request may be sent to a contact identifier associated with the user. The contact identifier generally provides an alternative way to contact the user and may include a telephone number for the user's smart, cell, or landline phone, an address associated with a user's client device 14, such as an Internet Protocol (IP) address or a media access code (MAC) address, and the like, or combinations thereof. Upon the user receiving the secondary authentication request, the user responds to the request to perform the secondary authentication. In some circumstances, such as embodiments of the present invention, the user's response to the secondary authentication request may also complete a tertiary authentication. For example, if the authentication system places a telephone call to the user's wireless communications device and presents to the user a prompt as described above, then receipt of the user's live oral response to the prompt accomplishes the secondary and tertiary authentications. The secondary authentication is having the user verify the phone call—along a different communications channel than the primary authentication—to establish something the user owns, namely the user's wireless communications device. The tertiary authentication is receiving the user's live oral response and performing the voice recognition of that response according to the above-described embodiments. As discussed above, a three-factor authentication system is only described as exemplary, and the voice recognition and prompt authentication system of embodiments of the present invention can be employed alone or in combination with other authentication methods.

As an even further example, the user may not be called and requested to provide a response as a live oral response to a question posed over the communications device. Instead, the user may complete the primary authentication along the first communications channel, such as “logging in” at the first client device 14. The authentication system may then pose the prompt either in text and on the screen of the first client device 14 or orally via speakers associated with the device 14. The user may then need to call a particular number or answer a call at a second client device, along a second communications channel that is different from the first communications channel, and provide the live oral response that is used as the live voice sample for the voice recognition and prompt authentication system of the present invention.

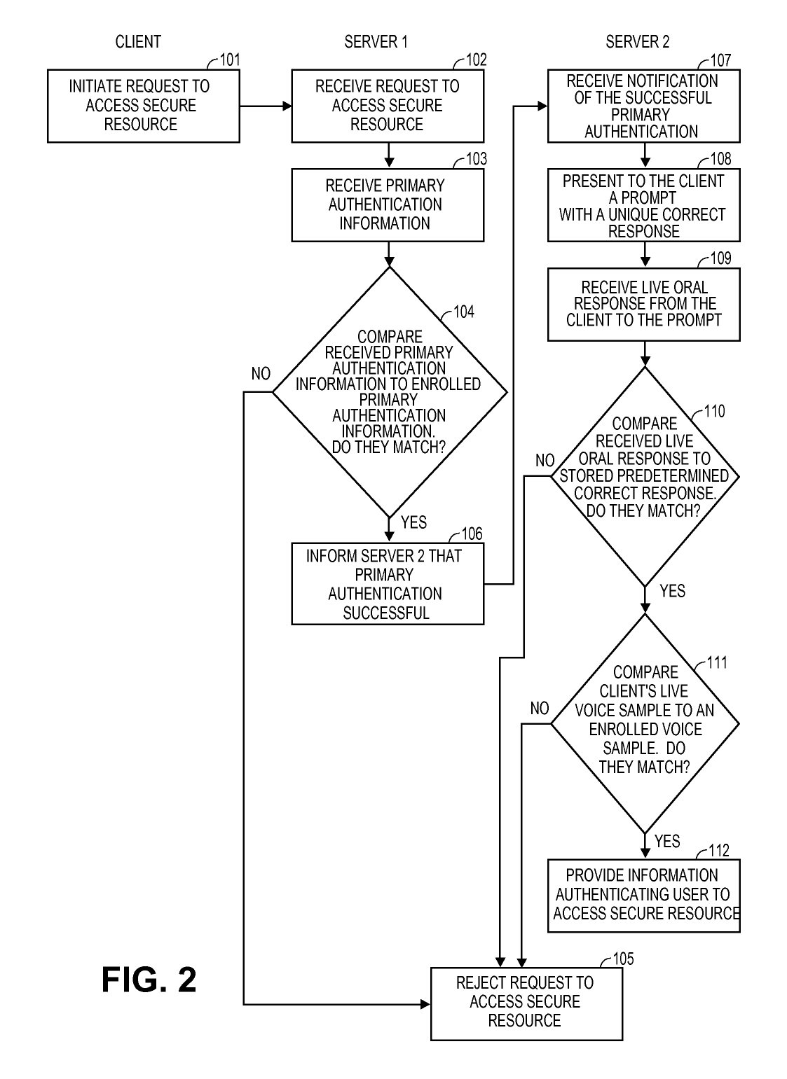

The computer program of the present invention comprises a plurality of code segments that implement the method of the present invention. Referring to FIG. 2, authentication of a user to access a secure resource in accordance with various embodiments of the present invention is illustrated. The steps of the method may be performed in the order shown in FIG. 2, or they may be performed in a different order. Furthermore, some steps may be performed concurrently as opposed to sequentially. Also, some steps may be optional. In general, when referring to FIG. 2, steps listed in the left column may be performed by a first client device 14, steps listed in the center column may be performed by a first server device 12, and steps listed in the right column may be performed by a second server device 12. In addition and as noted above, some of the steps listed may be part of the computer program of the present invention. Finally, some of the steps performed by the first server device may be performed by the second server device and vice-versa.

In step 101, a purported user initiates a request to access a secure resource. As described above, the secure resource is an online website, a mobile application, or other locked electronic location. In step 102, upon the user requesting access to the resource, the first server device (Server 1 in FIG. 2) receives the request to access the secure resource, and in step 103, the first server device requests and receives from the user the primary authentication information, such as the username and password. In step 104, the first server device compares the received primary authentication information to previously enrolled primary authentication information to determine if there is a match between the two. In alternative embodiments, another server device may perform the comparison and simply notify the first server device whether the primary authentication was successful. If the received and enrolled primary authentications do not match, then the request to access the secure resource is rejected, as depicted in step 105. In contrast, if the received and enrolled primary authentications do match, then in step 106 the first server device informs the second server device (Server 2 in FIG. 2) that the primary authentication was successful.

In step 107, the second server device receives a notification of the successful primary authentication. It should be understood that two server devices are not necessarily required, such that the primary authentication and the secondary authentication (comprising the voice recognition and the presentation of the prompt) could be performed by the same server device. In certain embodiments of the present invention, it is expected that the first server device will be associated with the secure resource and have access to the enrolled primary authentication information to perform the primary authentication. The second server device will not necessarily be associated with the first server device or under the control of an entity controlling the first server device, such that the second server device will only receive notification of a successful primary authentication. The second server device then uses this notification to begin its process of performing the remaining authentication steps.

In step 108, the second server device presents to the client a prompt with a unique correct response in accordance with the above-discussed embodiments. In step 109, the user responds to the question with a live oral response, which comprises the user's live voice sample. The computer program and method of the present invention then analyze the live voice sample for the authentication system as described above. In particular, in step 110, the live oral response is compared to a stored predetermined correct response to determine if they match. If they do not match, then the user's request to access the secure resource is rejected, as depicted in step 105. Alternatively, the method may present another prompt to the user, according to step 108, to allow the user a second opportunity to correctly respond to a prompt.

If the live oral response received from the user does match the stored predetermined correct response, then the computer program and method then perform voice recognition on the live voice sample to determine if the user's voice matches an enrolled voice sample, as depicted in step 111. As discussed above, embodiments of the present invention analyze the live oral response for both the accuracy of the provided response to the prompt and for verification that the voice is the same as an enrolled user's voice, referred to as voice recognition. If the voice recognition is unsuccessful, then the user's request to access the secure resource is rejected, as depicted in step 105. Alternatively, the method may request another live voice sample from the user to allow the user a second opportunity to complete the voice recognition step. If the voice recognition is successful, then at step 112, the second server device provides information authenticating the user to access the secure resource. Alternatively, the second server device could simply provide information that the secondary (and perhaps tertiary) authentication was successful. In even further alternatives, the second server device could authenticate the user directly to allow the user access to the secure resource.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A non-transitory computer-readable storage medium with an executable program stored thereon for authenticating a user to access a secure resource, wherein the program instructs a processor to perform the steps of:
enrolling a user's voice sample to obtain an enrolled voice sample, wherein enrollment comprises receiving from the user a plurality of enrollment utterances;
generating a set of prompts and respective predetermined correct responses for use in authenticating the user, wherein each predetermined correct response is unique, such that each prompt has only one correct response, and wherein the predetermined correct response to each prompt is widely known or determinable by the general public;
receiving information indicative of the user's request to access the secure resource;
performing an authentication of the user that insures a live voice sample provided by the user matches the user's enrolled voice sample and is not a prerecorded user voice sample or user voice samples that have been synthesized, assembled, or spliced together in a recording, said performing an authentication of the user comprising the steps of—
presenting to the user, via a user interface, a prompt selected from the set of prompts,
receiving in real time the user's live oral response to the presented prompt, wherein the live oral response provides the live voice sample,
comparing the received live oral response from the user to the predetermined correct response to the prompt to (1) determine if the user's live oral response matches the predetermined correct response; and (2) confirm the user's live voice sample matches the enrolled voice sample, and
providing information authenticating the user to access the secure resource if (1) the user's live oral response matches the predetermined correct response to the prompt; and (2) if the user's live voice sample matches the enrolled voice sample.

2. The computer-readable storage medium of claim 1,
wherein the authentication is a secondary authentication, and
wherein the program further instructs the processor to perform a primary authentication comprising the steps of:
enrolling a user's primary authentication information to obtain enrolled primary authentication information,
receiving from the user live primary authentication information,
determining if the live primary authentication information matches the enrolled primary authentication information, and
if the live primary authentication information matches the stored primary authentication information, generating information indicative of a successful primary authentication for use in instructing the processor to perform the secondary authentication.

3. The computer-readable storage medium of claim 2,
wherein the primary authentication is performed via a first communications channel, and the secondary authentication is performed via a second communications channel that is different from the first communications channel, and
wherein the user's live oral response is provided by the user via a communications device associated with the user.

4. The computer-readable storage medium of claim 3, wherein the user interface is selected from the group consisting of: a telephone communicating over a public switched telephone network, and a wireless communication device.

5. The computer-readable storage medium of claim 1, wherein the set of prompts has at least fifty questions from which the prompt to be presented to the user can be selected.

6. The computer-readable storage medium of claim 5, wherein selection of the prompt presented to the user from the set of prompts is random.

7. The computer-readable storage medium of claim 5, wherein selection of the prompt presented to the user from the set of prompts does not select a prompt presented to the user within at least the five previous authentications.

8. The computer-readable storage medium of claim 5, wherein the correct response to the prompt does not pertain to information personal to the user.

9. The computer-readable storage medium of claim 8, wherein the prompt requests the user solve a mathematical equation.

10. The computer-readable storage medium of claim 1, wherein the prompt is to repeat one or more words provided on a computing device associated with the user and in response to the user requesting access to the secure resource.

11. The computer-readable storage medium of claim 1, wherein the prompt is to repeat one or more words, and such words were not one of the plurality of enrollment utterances.

12. The computer-readable storage medium of claim 1, wherein the correct response to the prompt does not require the user to utter one of the plurality of enrollment utterances.

13. The computer-readable storage medium of claim 1, wherein the prompt is not an instruction to repeat one or more utterances, such that the user's oral response is the repeating of the one or more instructed utterances.

14. A method for authenticating a user to access a secure resource comprising the steps of:
enrolling electronically, via a processor, a user's voice sample to obtain an enrolled voice sample, wherein enrollment comprises receiving from the user, via a first electronic user interface, a plurality of enrollment utterances;
generating, via a processor, a set of prompts and respective predetermined correct responses for use in authenticating the user, wherein each predetermined correct response is unique, such that each prompt has only one correct response, and wherein the predetermined correct response to each prompt is widely known or determinable by the general public;
receiving information indicative of the user's request to access the secure resource;
performing an authentication of the user that insures a live voice sample provided by the user matches the user's enrolled voice sample and is not a prerecorded user voice sample or user voice samples that have been synthesized, assembled, or spliced together in a recording, said performing an authentication of the user comprising the steps of—
presenting to the user, via a user interface, a prompt selected from the set of prompts,
receiving in real time the user's live oral response to the presented prompt, wherein the live oral response provides the live voice sample,
comparing the received live oral response from the user to the predetermined correct response to the prompt to (1) determine if the user's live oral response matches the predetermined correct response; and (2) confirm the user's live voice sample matches the enrolled voice sample, and
providing information authenticating the user to access the secure resource if (1) the user's live oral response matches the predetermined correct response to the prompt; and (2) if the user's live voice sample matches the enrolled voice sample.

15. The method of claim 14, wherein the correct response to the prompt does not pertain to information personal to the user.

16. The method of claim 14, wherein the prompt requests the user solve a mathematical equation.

17. The method of claim 14, wherein the prompt is to repeat one or more words provided on a computing device associated with the user and in response to the user requesting access to the secure resource.

18. The method of claim 14, wherein the prompt is to repeat one or more words, and such words were not one of the plurality of enrollment utterances.

19. The method of claim 14, wherein the prompt is not an instruction to repeat one or more utterances, such that the user's oral response is the repeating of the one or more instructed utterances.

20. In a voice authentication method where an authentic user previously enrolled in a voice authentication system by verbally reciting a series of enrollment words sufficient to establish certain voice characteristics of the authentic user, and the authentic user thereafter seeks to have the system authenticate his or her voice by the verbal recitation of system-selected authentication words that allow the system to determine whether or not the authentic user has uttered the system-selected authentication words, the improvement comprising the step of asking a purportedly authentic user at least one question, and requiring the purportedly authentic user to verbally respond to the question, where the response to the question: (a) is widely known by the general public; (b) does not involve information personal to the authentic user; (c) is unique; (d) is not easily generated by a computer using assembled/spliced user voice samples in real time; and (e) permits the system to compare the purportedly authentic user's voice with the pre-established voice characteristics of the authentic user.
